(19) United States
(12) Patent Application Publication
(10) Pub. No.: US 2011/0149466 A1
(43) Pub. Date: Jun. 23, 2011

(54) MULTILAYER CERAMIC CAPACITOR

(75) Inventors: Seok Joon HWANG, Anyang (KR); Hae Suk Chung, Seoul (KR)

(73) Assignee: SAMSUNG ELECTRO-MECHANICS CO., LTD.

(21) Appl. No.: 12/880,674

(22) Filed: Sep. 13, 2010

(30) Foreign Application Priority Data
Dec. 22, 2009 (KR) 10-2009-0129303

(51) Int. Cl. H01G 4/01

(52) U.S. Cl. 361/303

(57) ABSTRACT

There is provided a multilayer ceramic capacitor. The multilayer ceramic capacitor includes a capacitor body including a plurality of inner electrodes and a plurality of dielectric layers alternated with the plurality of inner electrodes, and outer electrodes respectively disposed on both sides surfaces of the capacitor body and electrically connected with the inner electrodes. The inner electrodes are stacked such that three or more inner electrodes, electrically connected with the same outer electrode, are successively stacked and alternated with the dielectric layers.

### CROSS-REFERENCE TO RELATED APPLICATIONS

This application claims the priority of Korean Patent Application No. 10-2009-0129303 filed on Dec. 22, 2009, in the Korean Intellectual Property Office, the disclosure of which is incorporated herein by reference.

### BACKGROUND OF THE INVENTION

1. Field of the Invention

The present invention relates to a multilayer ceramic capacitor, and more particularly, to a multilayer ceramic capacitor capable of having a high level of strength and achieving improved connectivity between inner and outer electrodes.

2. Description of the Related Art

In general, a multilayer ceramic capacitor includes a plurality of ceramic dielectric sheets and inner electrodes interleaved with the plurality of ceramic dielectric sheets. Because the multilayer ceramic capacitor can implement a high capacitance for its small size and can be easily mounted on a substrate, it is commonly used as a capacitive component for various electronic devices.

Recently, as electronic products (i.e., home appliances, etc.) become compact and multi-functional, chip components have tended to become compact and highly functional. Following this trend, a multilayer ceramic capacitor is required to be smaller than ever before, but to have a high capacity. At present, a multilayer ceramic capacitor having five hundred or more dielectric layers, each with a thickness of 2 um or less stacked therein, is being fabricated.

In this respect, a dielectric layer is formed by using fine BaTiO₃ powder particles having a particle size ranging from 100 nm to 300 nm, in order to achieve a reduction in the thickness of the dielectric layer. However, a thin dielectric layer, formed using the fine powder particles, may increase capacitance, but tends to undesirably lower rated voltage and cause a rapid reduction in capacitance at a high temperature between 85° C. and 125° C. On the other hand, a thick dielectric layer, formed using the fine powder particles, causes a rapid reduction in capacitance at a low temperature of −55° C.

In order to attain desired temperature characteristics when a dielectric layer is formed using fine powder particles, the inner electrodes being stacked need to be designed such that they are either reduced in number or reduced in the overlapping area therebetween.

In the event that the inner electrodes are designed to have a reduced overlapping area therebetween, because of printing and stacking precision, a variation in overlapping areas between inner electrodes increases to thereby result in an increase in capacitance variations.

Therefore, a method for minimizing the number of inner electrodes needs to be taken into consideration. In this case, sufficient connectivity between inner and outer electrodes is not ensured, and the capacitance ratio of each dielectric layer becomes excessive for the overall chip capacitance. Thus, if the connectivity between the inner and outer electrodes is not ensured, capacitance standards cannot be met. Furthermore, as the number of inner electrodes being stacked is reduced, chip strength may also be impaired.

### SUMMARY OF THE INVENTION

An aspect of the present invention provides a multilayer ceramic capacitor having a high level of strength while stably ensuring connectivity between inner and outer electrodes.

According to an aspect of the present invention, there is provided a multilayer ceramic capacitor including: capacitor body including a plurality of inner electrodes and a plurality of dielectric layers alternated with the plurality of inner electrodes; and outer electrodes respectively disposed on both sides surfaces of the capacitor body and electrically connected with the inner electrodes. The inner electrodes are stacked such that three or more inner electrodes, electrically connected with the same outer electrode, are successively stacked and alternated with the dielectric layers.

A dielectric layer of the plurality of dielectric layers, located between the inner electrodes electrically connected to the same outer electrode, may have a smaller thickness than a dielectric layer of the plurality of dielectric layers, located between the inner electrodes electrically connected to the different outer electrodes.

A dielectric layer of the plurality of dielectric layers, located between the inner electrodes electrically connected to the same outer electrode, may have a greater thickness than a dielectric layer of the plurality of dielectric layers, located between the inner electrodes electrically connected to the different outer electrodes.

The dielectric layers may each be formed using fine powder particles having a particle size of 100 nm to 300 nm.

The dielectric layers may each have a thickness ranging from 1 um to 5 um.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view illustrating a multilayer ceramic capacitor according to an exemplary embodiment of the present invention;

FIG. 2 is a graph illustrating the dispersion of data points representing the capacitance of multilayer ceramic capacitors according to each design; and

FIG. 3 is a graph illustrating variations in the average values of breaking strength according to each design.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In describing the present invention, if a detailed explanation for a related known function or construction is considered to unnecessarily divert the gist of the present invention, such explanation will be omitted but would be understood by those skilled in the art.

The same or equivalent elements are referred to as the same reference numerals throughout the specification.

It will be understood that when an element is referred to as being “connected with” another element, it can be directly connected with the other element or may be indirectly connected with the other element with element(s) interposed therebetween. Unless explicitly described to the contrary, the word “comprise” and variations such as “comprises” or “comprising,” will be understood to imply the inclusion of stated elements but not the exclusion of any other elements.

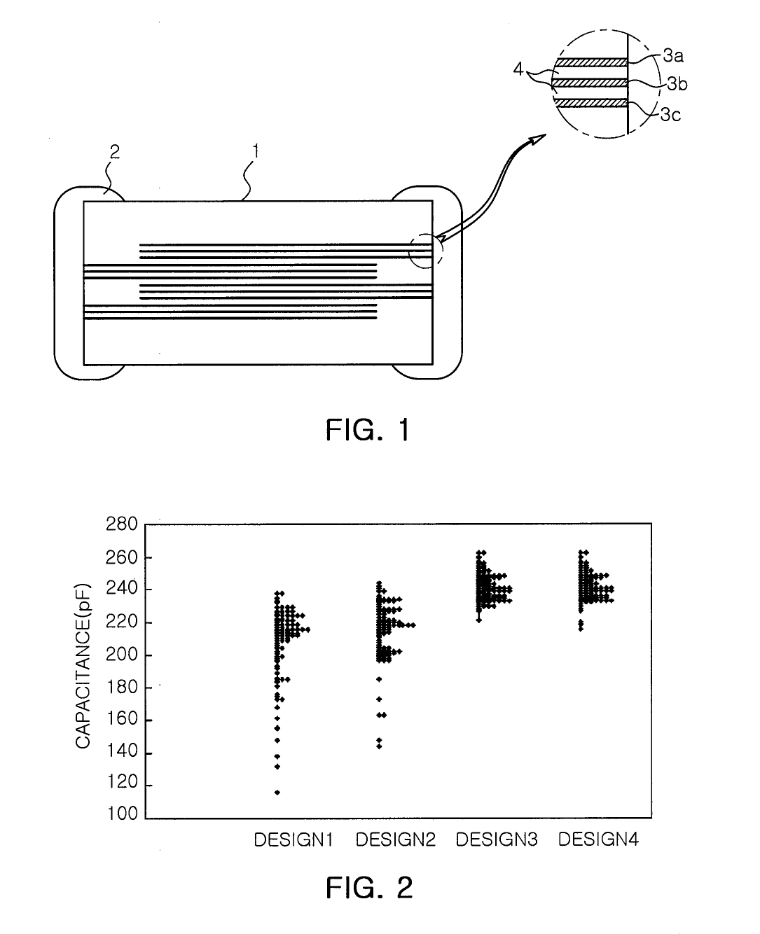

FIG. 1 is a cross-sectional view illustrating a multilayer ceramic capacitor according to an exemplary embodiment of the present invention.

Referring to FIG. 1, the multilayer ceramic capacitor, according to this exemplary embodiment of the present invention, may include a capacitor body 1, inner electrodes 3, dielectric layers 4, and outer electrodes 2.

The plurality of dielectric layers 4 are stacked inside the capacitor body 1, and the inner electrodes 3 may be interleaved with the plurality of dielectric layers 4. In this case, the dielectric layers 4 may be formed by using barium titanate (Ba₂TiO₃), and the inner electrodes may be formed of nickel (Ni), tungsten (W), cobalt (Co) or the like.

The outer electrodes 2 may be formed on both side surfaces of the capacitor body 1, respectively. The outer electrodes 2 may serve as external terminals by being electrically connected with the inner electrodes 3 exposed to the outer surface of the capacitor body 1. In this case, the outer electrodes 2 may be formed by using copper (Cu).

A method of stacking the inner electrodes 3 will now be described in more detail.

As for the inner electrodes 3, three or more inner electrodes 3a, 3b and 3c are electrically connected to the same outer electrode 2 and these inner electrodes 3a, 3b and 3c are alternated with the dielectric layers 4.

Since three or more inner electrodes 3a, 3b and 3c of like polarity are successively stacked as described above, the connectivity between the inner and outer electrodes 3 and 2 can be enhanced while the capacitance of the multilayer ceramic capacitor is maintained.

Even if three or more inner electrodes 3 of like polarity are successively stacked, effective dielectric layers affecting capacitance are those that are electrically connected with the different outer electrodes 2, namely, dielectric layers 4 stacked between inner electrodes 3 of opposite polarities. Thus, the capacitance can be maintained almost constant.

In the event that any one of the inner electrodes of like polarity that are successively stacked becomes disconnected from the outer electrode 2, the rest of the inner electrodes maintain contact therewith. This prevents the deterioration of capacitance.

In addition, the successive stack of the three or more inner electrodes 3a, 3b and 3c of like polarity may enhance breaking strength while retaining the capacitance of the multilayer ceramic capacitor.

In this case, in order to minimize the size of the multilayer ceramic capacitor, each dielectric layer 4, stacked between two successively stacked inner electrodes 3 of like polarity, may be thinner than each dielectric layer 4 stacked between two inner electrodes 3 of opposite polarities.

Alternatively, in order to enhance the breaking strength of the multilayer ceramic capacitor, a dielectric layer 4 stacked between two successively stacked inner electrodes of like polarity may be thicker than a dielectric layer 4 stacked between two inner electrodes of opposite polarities.

The amount of inner electrodes of like polarity that need to be effectively stacked in a successive manner can be confirmed through the following experiment.

Capacitance dispersion and breaking strength were measured with respect to a multilayer ceramic capacitor in which inner electrodes of like polarity are not successively stacked (hereinafter “design 1”), a multilayer ceramic capacitor in which two inner electrodes of like polarity are successively stacked (hereinafter “design 2”), a multilayer ceramic capacitor in which three inner electrodes of like polarity are successively stacked (hereinafter “design 3”), and a multilayer ceramic capacitor in which four inner electrodes of like polarity are successively stacked (hereinafter “design 4”).

In this experiment, the dielectric layers 4 were formed using fine barium titanate powder particles having a particle size of 100 nm to 300 nm, and each had a thickness of 1 um to 5 um.

FIG. 2 is a graph illustrating the capacitance dispersion of respective multilayer ceramic capacitors of those designs. A plurality of multilayer ceramic capacitors of each design were manufactured, and the capacitance levels of those multilayer ceramic capacitors were measured and indicated as dots in the graph.

Referring to FIG. 2, it can be seen that the capacitance levels were significantly reduced in part in the case of designs 1 and 2, while the capacitance levels were stably realized in the case of designs 3 and 4.

This implies that a significant effect of realizing stable capacitance is obtained when three or more inner electrodes 3 of like polarity are successively stacked.

TABLE 1
(Unit: N)

| No. | Design 1 | Design 2 | Design 3 | Design 4 |
|---|---|---|---|---|
| 1 | 851 | 1034 | 1554 | 1658 |
| 2 | 904 | 975 | 1656 | 1664 |
| 3 | 722 | 1046 | 1754 | 1846 |
| 4 | 893 | 1198 | 1844 | 1666 |
| 5 | 956 | 902 | 1535 | 1589 |
| Average | 865 | 1031 | 1669 | 1685 |

Table 1 above shows the values of the breaking strength of the multilayer ceramic capacitors according to each design. Five multilayer ceramic capacitors were manufactured for each design and the values of the breaking strength of those multilayer ceramic capacitors were measured and then averaged.

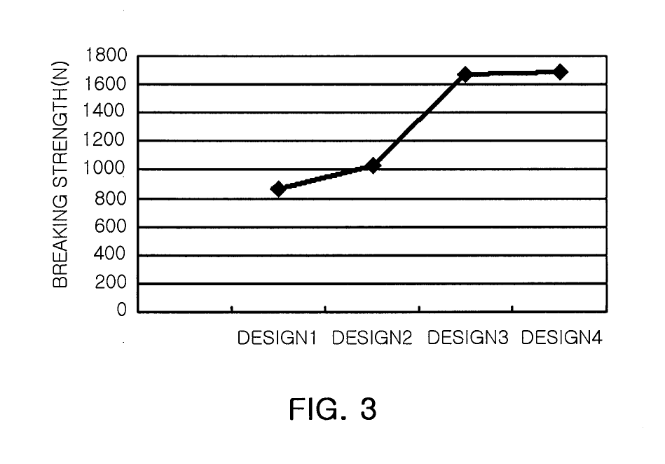

FIG. 3 is a graph illustrating a change in the average value of the breaking strength according to each design, shown in Table 1.

Referring to Table 1 and FIG. 3, it can be seen that the breaking strength significantly increases between design 2 and design 3.

That is, the improvement of the breaking strength becomes significant when three or more inner electrodes 3 of like polarity are stacked in a successive manner.

The above-described experiment confirms that a multilayer ceramic capacitor, including three or more successively stacked inner electrodes of like polarity, has a significant effect in terms of the implementation of stable capacitance and high breaking strength.

As set forth above, in the multilayer ceramic capacitor according to exemplary embodiments of the invention, three or more inner electrodes of like polarity are stacked, thereby stably ensuring connectivity between inner and outer electrodes.

Furthermore, the number of stacked inner electrodes affecting capacitance is reduced; however, the total number of inner electrodes is increased to thereby enhance strength.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayer ceramic capacitor comprising:
a capacitor body including a plurality of inner electrodes and a plurality of dielectric layers alternated with the plurality of inner electrodes; and
outer electrodes respectively disposed on both sides surfaces of the capacitor body and electrically connected with the inner electrodes,
wherein the inner electrodes are stacked such that three or more inner electrodes, electrically connected with the same outer electrode, are successively stacked and alternated with the dielectric layers.

2. The multilayer ceramic capacitor of claim 1, wherein a dielectric layer of the plurality of dielectric layers, located between the inner electrodes electrically connected to the same outer electrode, has a smaller thickness than a dielectric layer of the plurality of dielectric layers, located between the inner electrodes electrically connected to the different outer electrodes.

3. The multilayer ceramic capacitor of claim 1, wherein a dielectric layer of the plurality of dielectric layers, located between the inner electrodes electrically connected to the same outer electrode, has a greater thickness than a dielectric layer of the plurality of dielectric layers, located between the inner electrodes electrically connected to the different outer electrodes.

4. The multilayer ceramic capacitor of claim 1, wherein the dielectric layers are each formed using fine powder particles having a particle size of 100 nm to 300 nm.

5. The multilayer ceramic capacitor of claim 1, wherein the dielectric layers each have a thickness ranging from 1 um to 5 um.
